(19) United States
(12) Patent Application Publication
(10) Pub. No.: US 2022/0185189 A1
(43) Pub. Date: Jun. 16, 2022

(54) STAIR ASSEMBLY

(71) Applicant: Wildcat Cable Solutions, LLC, Magnolia, TX (US)

(72) Inventors: John Jay HOUSTON, Conroe, TX (US); Jeffrey Michael CONTER, Conroe, TX (US)

(21) Appl. No.: 17/118,326

(22) Filed: Dec. 10, 2020

(51) Int. Cl. B60R 3/02; E04F 11/06; E04F 11/022; E04F 11/18

(52) U.S. Cl. CPC B60R 3/02; E04F 11/1802; E04F 11/022; E04F 11/068

(57) ABSTRACT

A stair assembly for a vehicle includes a housing having a platform mounted on a first sliding frame. A step module having a plurality of steps is mounted on a second sliding frame, and the second sliding frame is mounted on the first sliding frame. The step module is stowed in the housing, and the housing with the step module is stowed in the vehicle. The housing and step module are deployed by operating the first and second sliding frames.

### BACKGROUND

### Field

Embodiments of the present disclosure generally relate to a stair assembly that is suitable for installation on a vehicle, such as a truck, a recreational vehicle, a trailer, and the like.

### Description of the Related Art

It is common for vehicles, such as trucks, recreational vehicles, trailers, and other such movable conveyances to have one or more doors permitting ingress and egress. A door may be located at a height above ground level that provides difficulty for a person to safely or comfortably enter and/or exit a vehicle. A vehicle may have steps or stairs in order to facilitate ingress and egress. If the steps or stairs are non-movably fixed to the vehicle, the steps or stairs may add to the width or length of the vehicle, making it difficult for the vehicle to be maneuvered in tight spaces. A vehicle may have movable steps that are stored within the vehicle, and are deployed for use. However, such steps often provide limited space for a person to move while manipulating a door on the vehicle, and when deployed, the steps may move under the weight of the person, thereby compromising the person's comfort and safety.

There is a need for an improved stair assembly that combines the benefits of compact storage with robustness and space for a person's comfort and safety.

### SUMMARY

The present disclosure generally relates to a stair assembly that is suitable for installation on a vehicle or other movable conveyance, such as a truck, a recreational vehicle, a trailer, emergency response vehicle, law enforcement vehicle, industrial vehicle, military vehicle, and the like. In one embodiment, a stair assembly includes a first slide assembly. The first slide assembly includes a first base frame and a first sliding frame mounted to the first base frame. The first sliding frame is operable to slide horizontally with respect to the first base frame between retracted and extended positions. A housing is mounted to the first sliding frame. The housing includes a platform. A second slide assembly is mounted to the first sliding frame and includes a second base frame and a second sliding frame mounted to the second base frame. The second sliding frame is operable to slide horizontally with respect to the second base frame between retracted and extended positions. A first step module is mounted to the second sliding frame, and includes a plurality of steps. When the second sliding frame is in the retracted position, the first step module is located in the housing between the first sliding frame and the platform.

In another embodiment, a stair assembly includes a first slide assembly. The first slide assembly includes a first base frame and a first sliding frame mounted to the first base frame. The first sliding frame is operable to slide horizontally in a first direction with respect to the first base frame between retracted and extended positions. A housing is mounted to the first sliding frame. The housing includes a first fascia coupled to a first end of the first sliding frame, a second fascia coupled to a second opposite end of the first sliding frame, and a platform coupled to the first and second fasciae. The platform, first and second fasciae, and first sliding frame define an interior volume. A second slide assembly is mounted to the first sliding frame and includes a second base frame and a second sliding frame mounted to the second base frame. The second sliding frame is operable to slide horizontally in a second direction with respect to the second base frame between retracted and extended positions. The second direction is perpendicular to the first direction. A first step module is mounted to the second sliding frame, and includes first and second sidewalls, and a plurality of steps. Each step is coupled to the first and second sidewalls. When the second sliding frame is in the retracted position, the first step module is located within the interior volume.

In another embodiment, a method of deploying a step assembly includes horizontally moving a platform mounted on top of a sliding frame with respect to a base frame. The sliding frame bears at least a portion of a weight of the platform. The method further includes horizontally moving a first step module mounted on top of the sliding frame and below the platform with respect to the platform. The first step module comprises a plurality of first steps. The method further includes moving a second step module with respect to the first step module from a stowed position to a deployed position. The second step module is coupled to the first step module and includes a plurality of second steps.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a perspective view of a stair assembly arranged in a stowed configuration.

FIG. 2 is a perspective view of the stair assembly of FIG. 1 after a first deployment operation.

FIG. 3 is a perspective view of the stair assembly of FIG. 1 after a second deployment operation.

FIGS. 4A to 4C are perspective views of the stair assembly of FIG. 1 after a third deployment operation.

FIG. 5 is a perspective view of a component of the stair assembly of FIG. 1.

FIG. 6A is a perspective view of another component of the stair assembly of FIG. 1 in a retracted configuration.

FIGS. 6B and 6C are perspective views of portions of the component of FIG. 6A.

FIG. 6D is a perspective view of the component of FIG. 6A in an extended configuration.

FIG. 6E is a perspective view of the underside of a portion of the component of FIG. 6A in an extended configuration.

FIG. 7A is a perspective view of another component of the stair assembly of FIG. 1 in a retracted configuration.

FIGS. 7B and 7C are perspective views of portions of the component of FIG. 7A.

FIG. 7D is a perspective view of the component of FIG. 7A in an extended configuration.

FIG. 7E is a perspective view of the underside of a portion of the component of FIG. 7A in an extended configuration.

FIG. 8 is a perspective view showing the component of FIGS. 7A-7E mounted on the component of FIGS. 6A-6E.

FIGS. 9A and 9B are perspective views of another component of the stair assembly of FIG. 1.

FIG. 10 is a perspective view of the stair assembly of FIG. 1 following deployment from a vehicle.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to a stair assembly that is suitable for installation on a vehicle or other movable conveyance, such as a truck, a recreational vehicle, a trailer, emergency response vehicle, law enforcement vehicle, industrial vehicle, military vehicle, and the like. The stair assembly may be stowed as a compact unit in or on the vehicle, and may be deployed into a configuration that provides a robust and spacious stairway.

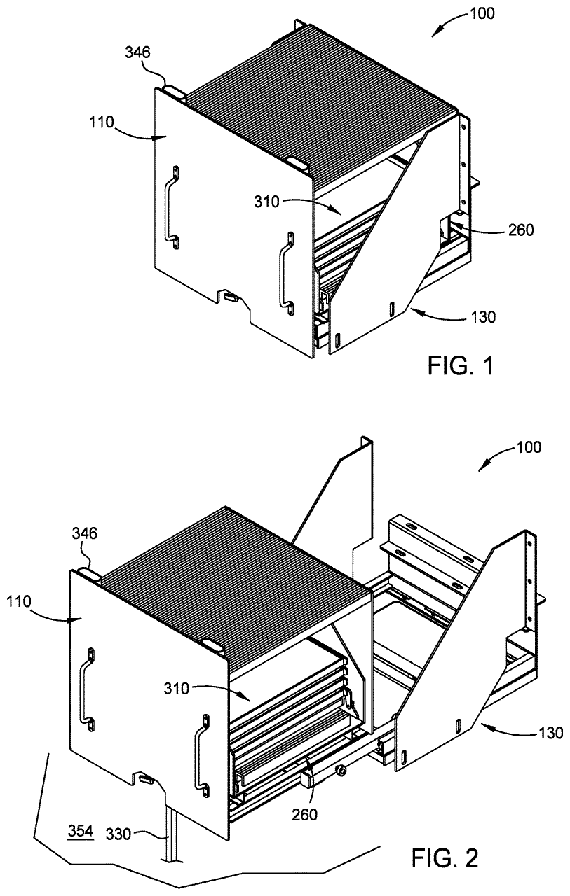

FIG. 1 is a perspective view of a stair assembly 100 in a stowed configuration. When the stair assembly 100 is installed on a vehicle, the stowed configuration of FIG. 1 represents situations in which the stair assembly 100 is stored when not deployed for use. The stair assembly 100 includes a housing 110 and a lower, or first, slide assembly 130. As shown, a first step module 260 and a second step module 310 are contained within the housing 110. In some embodiments, the second step module 310 may be omitted or may be stored elsewhere than within the housing 110.

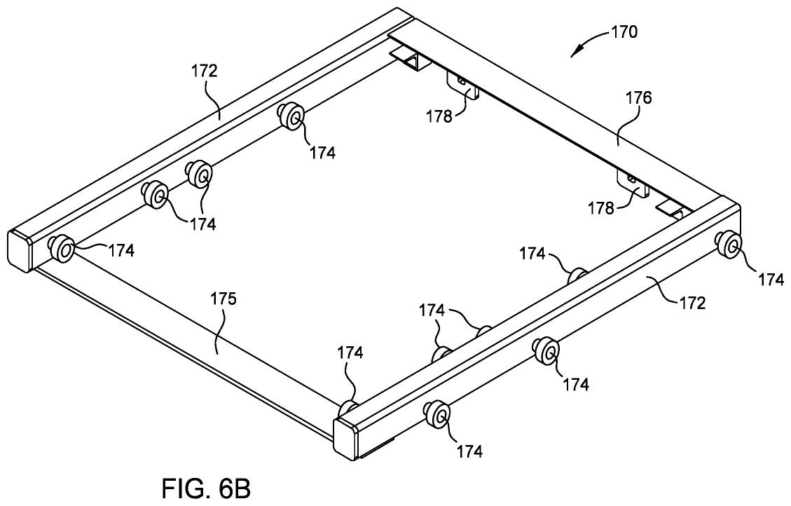

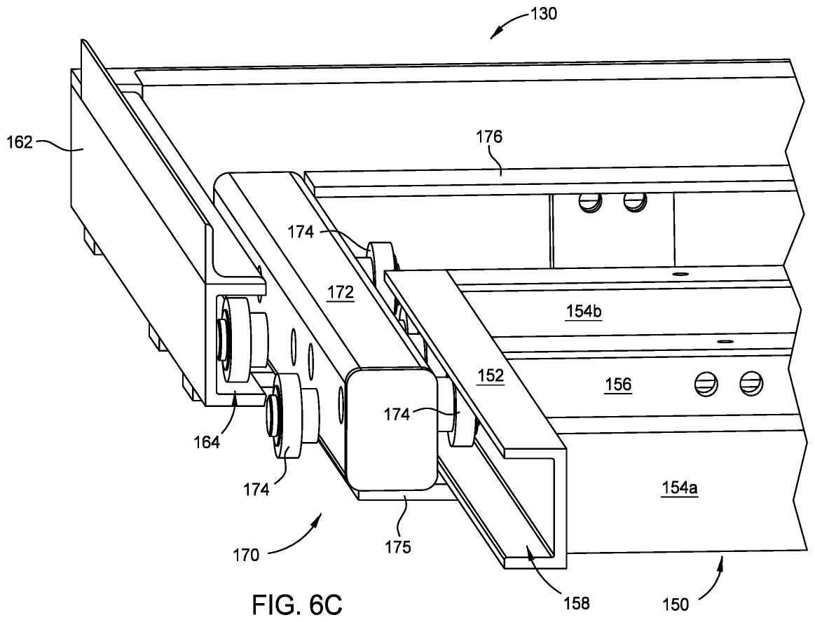

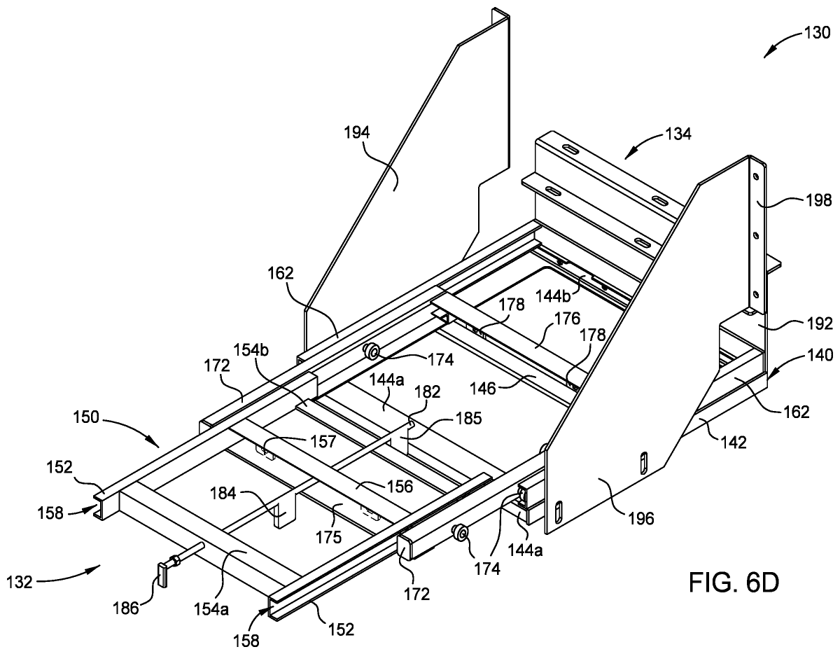

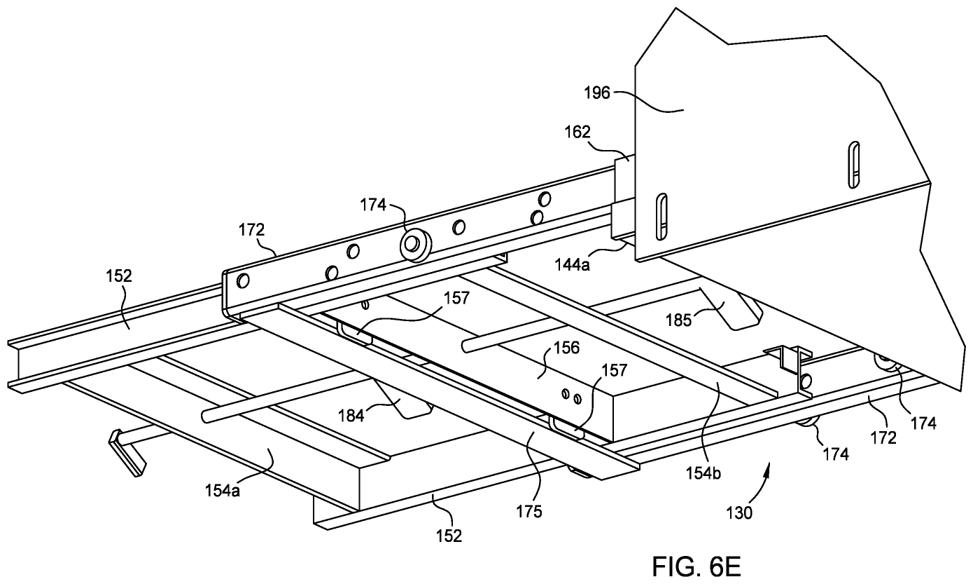

The lower slide assembly 130 is shown in greater detail in FIGS. 6A to 6E. FIG. 6A shows the lower slide assembly 130 in a retracted configuration which corresponds to the position of the lower slide assembly 130 when the stair assembly 100 is in the stowed configuration of FIG. 1. FIGS. 6D and 6E show an underside view of a portion of the lower slide assembly 130 in an extended configuration.

As shown in FIG. 6A, the lower slide assembly 130 has a base frame 140 and a sliding frame 150. The lower slide assembly 130 has a front 132 and a rear 134. The base frame 140 is a rectangular structure including side struts 142 with crossbeams 144a, 144b connecting the side struts 142 at the front 132 and the rear 134, respectively. A bracing beam 146 connects between the side struts 142 part-way along a length of the base frame 140. It is contemplated that the base frame 140 may include any suitable number of bracing beams 146. The number of bracing beams 146 may be selected in order to provide an appropriate structural rigidity of the base frame 140.

The sliding frame 150 is mounted on the base frame 140. The sliding frame 150 is a rectangular structure including side struts 152 with crossbeams 154a, 154b connecting the side struts 152 at or near the front 132 and the rear 134, respectively. A bracing beam 156 connects between the side struts 152 part way along a length of the sliding frame 150. A stop plate 157 is attached to the bracing beam 156, and projects downward. It is contemplated that the sliding frame 150 may include any suitable number of bracing beams 156 and stop plates 157. The number of bracing beams 156 may be selected in order to provide an appropriate structural rigidity of the sliding frame 150. Each sliding frame 150 side strut 152 is formed as a beam having a U-shaped channel 158 along the length of the beam, with the opening of the U-shape facing outward from the sliding frame 150. In some embodiments, the channel along the length of the beam of each sliding frame 150 side strut 152 may take the form of a different shape. For example, the channel may be V-shaped, or may be open on one side, defining an L-shape.

As shown in FIG. 6A, a stationary member 162 is disposed atop each side strut 142 of the base frame 140. Each stationary member 162 is securely fastened to the respective base frame 140 side strut 142, such as by a weld. In some embodiments, each stationary member 162 and base frame 140 side strut 142 pair may be formed as an integral structure. Each stationary member 162 is formed as a beam having a U-shaped channel 164 along the length of the beam, with the opening of the U-shape facing toward the sliding frame 150. In some embodiments, the channel along the length of the beam of each stationary member 162 may take the form of a different shape. For example, the channel may be V-shaped, or may be open on one side, defining an L-shape.

The sliding frame 150 is disposed above the base frame 140 and between each stationary member 162, and thus the opening of each sliding frame 150 side strut 152 faces the opening of the corresponding stationary member 162. A bearing assembly 170 connects each sliding frame 150 side strut 152 with a corresponding stationary member 162. The bearing assembly 170 is also illustrated schematically in FIG. 68. The bearing assembly 170 includes an intermediate beam 172 at each side, a connecting crossbeam 175 at the front, and a bump stop 176 extends from one intermediate beam 172 to the other intermediate beam 172 at the rear. The bump stop 176 is configured to inhibit movement of the sliding frame 150 beyond the rear of the bearing assembly 170. One or more stop plates 178 (two are illustrated) are attached to the bump stop 176, and project downward.

The arrangement of the base frame 140, bearing assembly 170, and sliding frame 150 is also illustrated schematically in FIG. 6C. Each intermediate beam 172 is located between each sliding frame 150 side strut 152 and the corresponding stationary member 162, such that each intermediate beam 172 is substantially parallel with the corresponding sliding frame 150 side strut 152 and the corresponding stationary member 162. Rollers 174, such as wheels, are affixed to each intermediate beam 172 such that some rollers 174 project into the U-shaped channel 164 of each stationary member 162, and other rollers 174 project into the U-shaped channel 158 of each corresponding sliding frame 150 side strut 152. As best shown in FIG. 6B, it is contemplated that the vertical positioning of some of the rollers 174 may be staggered.

The bearing assembly 170 is arranged such that the sliding frame 150 can move with respect to the base frame 140 along a direction parallel to the orientation of the U-shaped channels 164 of the stationary members 162 and the U-shaped channels 158 of the corresponding sliding frame 150 side struts 152. Thus, as illustrated in FIGS. 6A to 6E, when the base frame 140 is mounted such that the U-shaped channels 164 of the stationary members 162 and the U-shaped channels 158 of the corresponding sliding frame 150 side struts 152 are horizontal, the sliding frame 150 can move horizontally with respect to the base frame 140. The stationary members 162 and the bearing assembly 170 are arranged such that the intermediate beam 172 of the bearing assembly 170 is separated vertically from the base frame 140. The bearing assembly 170 and the sliding frame 150 side struts 152 are arranged such that the sliding frame 150 side struts 152, the sliding frame 150 crossbeams 154a, 154b, and the sliding frame 150 bracing beam 156 are separated vertically from the base frame 140.

When the sliding frame 150 is in the position as shown in FIG. 6A, the sliding frame 150 is in a retracted position and the lower slide assembly 130 is in the retracted configuration. When the sliding frame 150 is in the position as shown in FIGS. 6D and 6E, the sliding frame 150 is in an extended position and the lower slide assembly 130 is in the extended configuration. The sliding frame 150 has a fastener 180 that facilitates the securement of the sliding frame 150 in the retracted position. As illustrated, the fastener 180 includes a rod 182 with a tang 184 attached thereto. The tang 184 interacts with the base frame 140 bracing beam 146, thereby preventing movement of the sliding frame 150 from the retracted position as shown in FIG. 6A to the extended position as shown in FIGS. 6D and 6E. The fastener 180 is unlocked by rotating the rod 182, such as by manipulating the attached handle 186, until the tang 184 is clear of the base frame 140 bracing beam 146. It is contemplated that one or more other locking mechanisms may be used in place of, or in addition to, the fastener 180.

Continuing with FIG. 6A, the base frame 140 is attached to a rear mounting plate 192, a first side mounting plate 194, and a second side mounting plate 196. The rear mounting plate 192 is attached to the crossbeam 144b at the rear 134 of the base frame 140, and extends upwards such that the bump stop 176 of the bearing assembly 170 is located between the sliding frame 150 and the rear mounting plate 192. Thus, the bump stop 176 is supported by the rear mounting plate 192 against any impact or force from the sliding frame 150. As illustrated, the rear mounting plate 192 has a flange 198 that facilitates connection to a suitable structure of a vehicle. In some embodiments, the rear mounting plate 192 may extend downwards from the base frame 140 in addition to, or as an alternative to, extending upwards. Furthermore, it is contemplated that one or more other flange or other connection point may be located at any suitable location of the rear mounting plate 192 in order to facilitate connection to a suitable structure of a vehicle.

Each side mounting plate 194, 196 is attached to a corresponding side strut 142 of the base frame 140. As illustrated, each side mounting plate 194, 196 is attached towards the front 132 of the base frame 140 and extends upwards and towards the rear 134 of the base frame 140. As illustrated, each side mounting plate 194, 196 has a flange 198 that facilitates connection to a suitable structure of a vehicle. In some embodiments, each side mounting plate 194, 196 may extend downwards from the base frame 140 in addition to, or as an alternative to, extending upwards. Furthermore, it is contemplated that one or more other flange or other connection point may be located at any suitable location of each side mounting plate 194, 196 in order to facilitate connection to a suitable structure of a vehicle.

FIGS. 6D and 6E illustrate views from above and below, respectively, of the lower slide assembly 130 in an extended configuration after unlocking the fastener 180 and moving the sliding frame 150 horizontally with respect to the base frame 140. Two stop plates 157 interact with the crossbeam 175 of the bearing assembly 170, thereby preventing further extension of the sliding frame 150 with respect to the bearing assembly 170. Two stop plates 178 of the bearing assembly 170 interact with the bracing beam 146 of the base frame 140, thereby preventing further extension of the bearing assembly 170 with respect to the base frame 140. As illustrated, the sliding frame 150 has moved with respect to the base frame 140 a greater distance than the bearing assembly 170 has moved with respect to the base frame 140.

As illustrated in FIGS. 6D and 6E, the sliding frame 150 has an additional fastener including a tang 185 that facilitates the securement of the sliding frame 150 in the extended position. Tang 185 interacts with the crossbeam 144a of the base frame 140 located at the front 132 of the base frame 140, such that the sliding frame 150 is inhibited from moving horizontally toward the retracted position. The additional tang is attached to the rod 182 of the fastener 180, and may be operated in a similar fashion to the fastener 180. In some embodiments, it is contemplated that the additional fastener including tang 185 may be omitted.

In some embodiments, it is contemplated that the sliding frame 150 may be powered to move between the retracted and extended positions. For example, the sliding frame 150 may be hydraulically or pneumatically actuated by a piston-and-cylinder arrangement. Alternatively, one or more electric motors and suitable gearing may be used to move the sliding frame 150. It is contemplated that movement of the sliding frame 150 between the retracted and extended positions may be controlled from within the vehicle in which the stair assembly 100 is installed, such as by pushing a button or selecting a command on a menu. It is contemplated that movement of the sliding frame 150 between the retracted and extended positions may be controlled remotely from a key fob or by using a program installed on a mobile communications device, such as a smartphone, smartwatch, tablet, and the like.

In order to provide structural rigidity of the base frame 140, the sliding frame 150, and the bearing assembly 170, it is contemplated that the base frame 140, the sliding frame 150, and the bearing assembly 170 may be made from a strong and rigid material, such as a metal, such as steel. Other materials, such as composite materials, such as materials incorporating carbon fibers, are also contemplated.

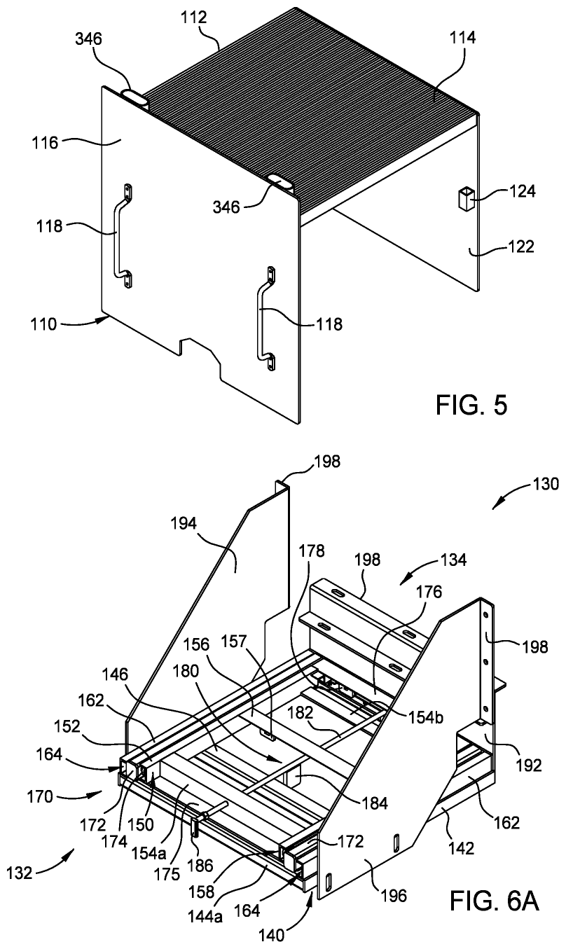

Returning to FIG. 1, the housing 110 is attached to the sliding frame 150 of the lower slide assembly 130. As shown in FIG. 5, the housing 110 includes a platform 112. The platform 112 is configured to facilitate a person standing thereon. It is contemplated that the platform 112 may have an upper surface 114 that inhibits the tendency of a person to slip. For example, the upper surface 114 may be treated with a non-slip coating, may include ridges or undulations, may include a non-slip matting, such as a rubber mat, or combination(s) thereof. The platform 112 is attached to an upper portion of a front fascia 116 that has a handgrip 118. The handgrip 118 facilitates movement of the stair assembly 100 during deployment and stowage. The platform 112 is also attached to an upper portion of a rear fascia 122.

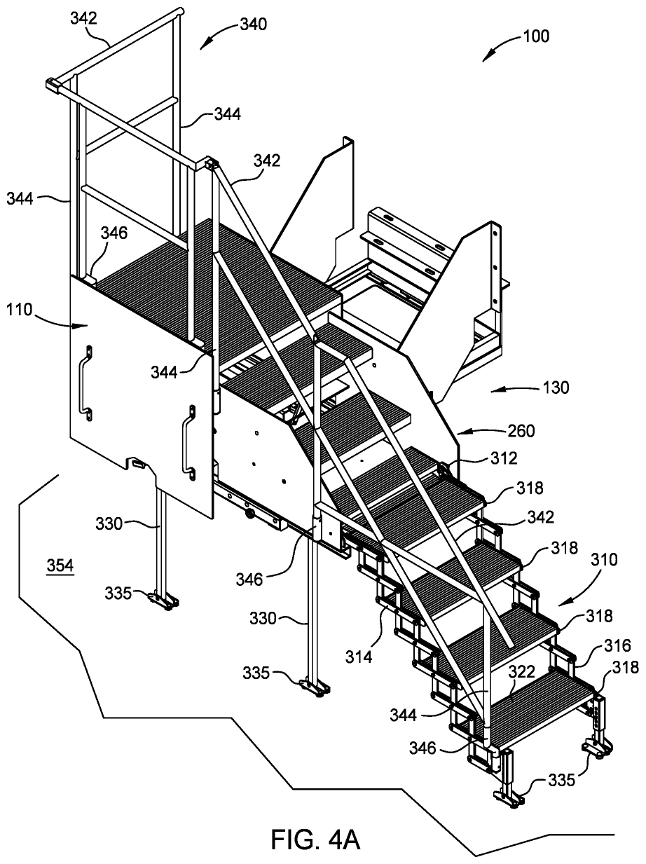

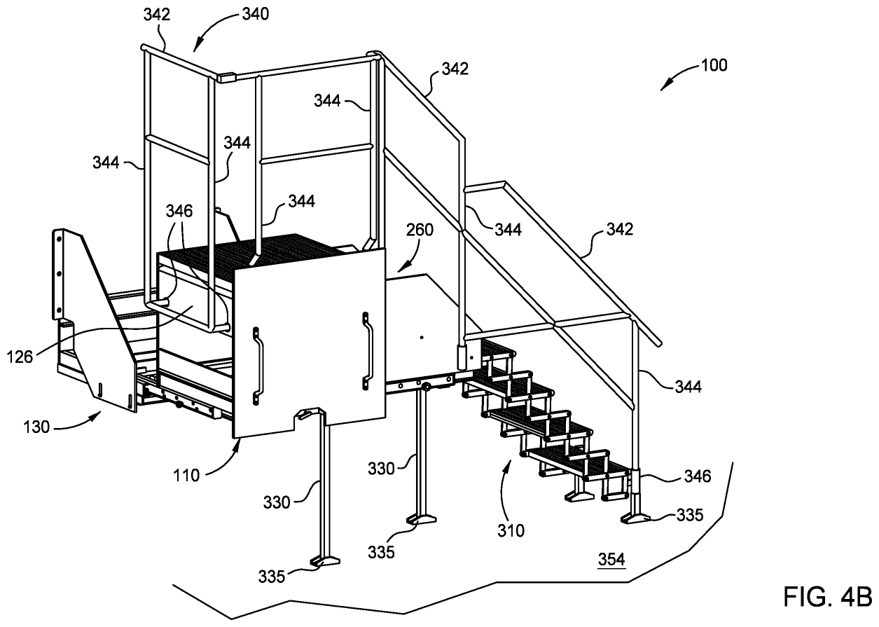

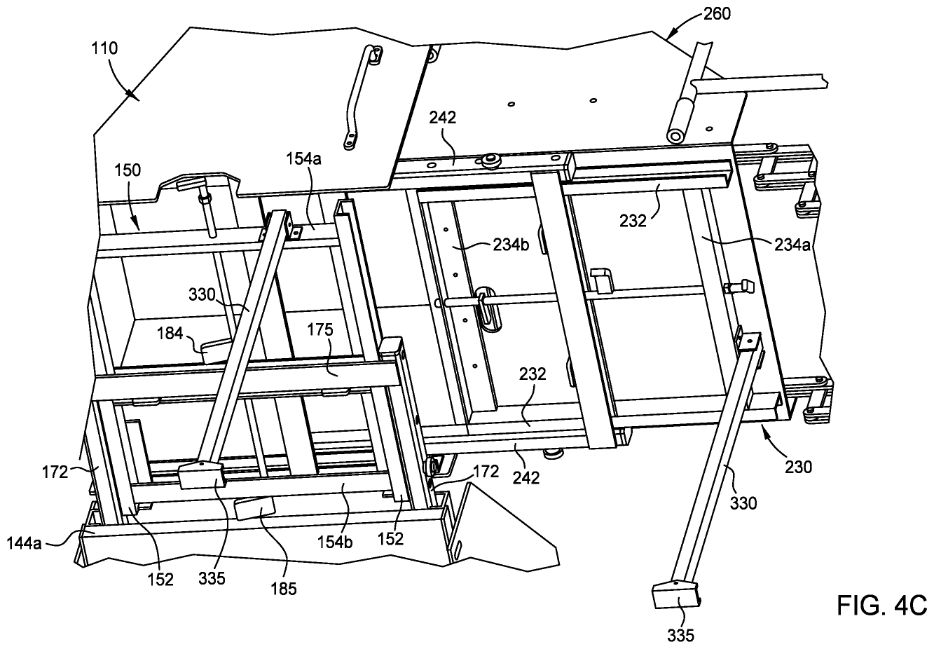

The housing 110 also includes mounting points, such as receptacles 346, with each receptacle 346 being configured to receive a post 344 of a handrail assembly 340, as shown in FIGS. 4A and 4B. FIG. 5 illustrates receptacles 346 positioned at the intersection between the platform 112 and the front fascia 116. FIG. 4B illustrates receptacles 346 positioned in a side fascia 126 of the housing 110. In some embodiments, it is contemplated that one or more receptacles 346 may be positioned along an edge of the platform 112 between the front fascia 116 and the rear fascia 122. When the stair assembly 100 is mounted to a vehicle and is in the stowed configuration, the front fascia 116 may be substantially flush with a surrounding side panel of the vehicle.

It is contemplated that the platform 112, front fascia 116, and rear fascia 122 may be made from strong and rigid material, such as a metal, such as steel, or from a relatively light weight yet strong and rigid material, such as aluminum. Other materials, such as composite materials, such as materials incorporating carbon fibers, are also contemplated.

As shown in FIG. 1, a lower portion of the front fascia 116 is attached to the front crossbeam 154a of the sliding frame 150 of the lower slide assembly 130. A lower portion of the rear fascia 122 is attached to the rear crossbeam 154b of the sliding frame 150 of the lower slide assembly 130. Thus, the platform 112, the front fascia 116, the rear fascia 122, and the sliding frame 150 of the lower slide assembly 130 define boundaries of an interior volume of the housing 110. As shown in FIG. 1, when the stair assembly 100 is in the stowed configuration, the first step module 260 is contained within the interior volume of the housing 110. As shown in FIG. 1, when the stair assembly 100 is in the stowed configuration, and a second step module 310 is present, the second step module 310 is contained within the interior volume of the housing 110.

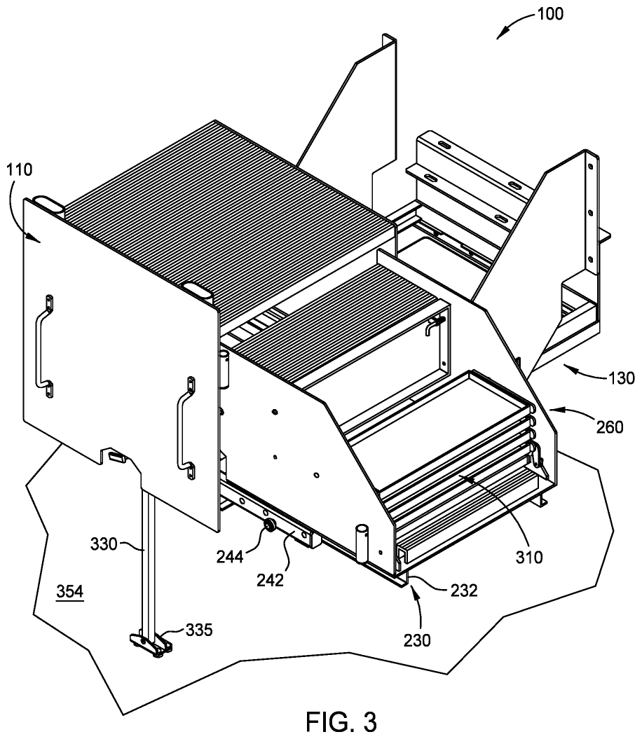

FIG. 2 is a perspective view of the stair assembly 100 after a first deployment operation. In order to transition from the stowed configuration of FIG. 1 to the position shown in FIG. 2, the fastener 180 that retains the sliding frame 150 of the lower slide assembly 130 in the retracted position is unlocked, and then the lower slide assembly 130 sliding frame 150 is moved to the extended position. It is contemplated that the unlocking of the fastener 180 may be performed manually, such as by turning the handle 186, or by prompting the fastener 180 to unlock via an electronic controller, such as by pressing a button, or such like. It is contemplated that the moving of the lower slide assembly 130 sliding frame 150 to the extended position may be performed manually, such as by pulling on the handgrip 118 attached to the front fascia 116 of the housing 110. As described above, in some embodiments the lower slide assembly 130 sliding frame 150 is powered to move between the retracted and extended positions. It is contemplated that the lower slide assembly 130 sliding frame 150 may be locked in the extended position after moving the housing 110 of the stair assembly 100 to the position shown in FIG. 2.

The lower slide assembly 130 sliding frame 150 bears at least a portion of a weight of the housing 110, and therefore the lower slide assembly 130 sliding frame 150 bears at least a portion of a weight of the platform 112, the front fascia 116, and the rear fascia 122. One or more legs 330 are deployed between the housing 110 and a ground surface 354. The one or more legs 330 are configured to transfer a load to the ground surface 354. FIG. 4C shows the one or more legs 330 are attached to the lower slide assembly 130 sliding frame 150. It is contemplated that additionally or alternatively, the one or more legs 330 may be attached to the housing 110. Each leg 330 has a foot 335 configured to rest on the ground surface 354. The feet 335 are configured to transfer a load to the ground surface 354. A height between the lower slide assembly 130 and each foot 335 is adjustable. In some embodiments, the one or more legs 330 may be configured to pivot with respect to the lower slide assembly 130 sliding frame 150 between stowed and deployed positions. In some embodiments, the one or more legs 330 may be telescopically adjustable with respect to the lower slide assembly 130 sliding frame 150, and may be telescopically adjustable between stowed and deployed positions. In some embodiments, the one or more legs 330 may be configured to pivot with respect to the lower slide assembly 130 sliding frame 150, and may be telescopically adjustable with respect to the lower slide assembly 130 sliding frame 150. Alternatively, it is contemplated that the one or more legs 330 may be stowed unattached to the lower slide assembly 130 sliding frame 150, and then may be attached to the lower slide assembly 130 sliding frame 150 to extend to the ground surface 354 after moving the housing 110 of the stair assembly 100 to the position shown in FIG. 2. In some embodiments, the one or more legs 330 may be omitted such that the housing 110 and lower slide assembly 130 sliding frame 150 remain cantilevered from the lower slide assembly 130 base frame 140 when in the extended position.

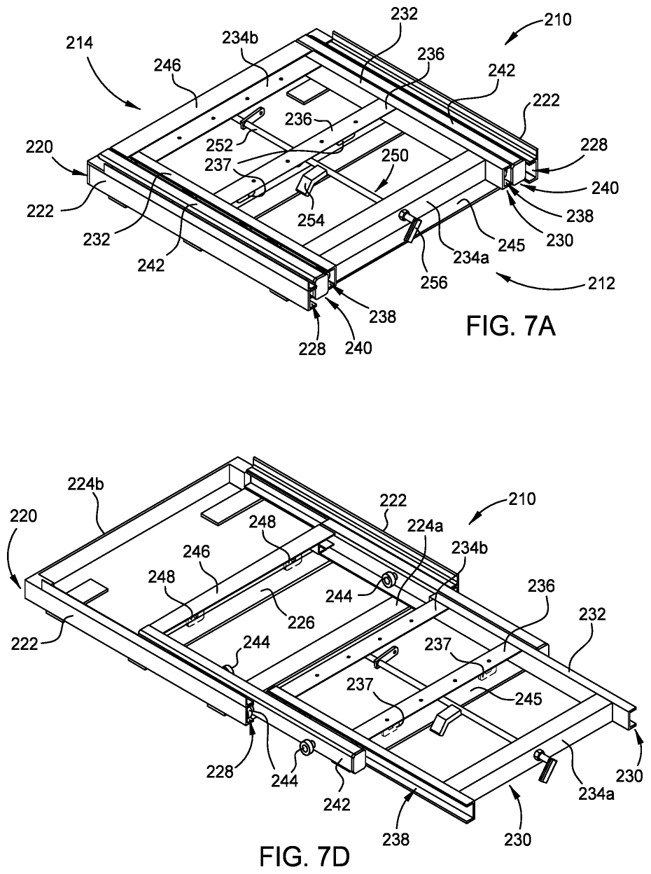

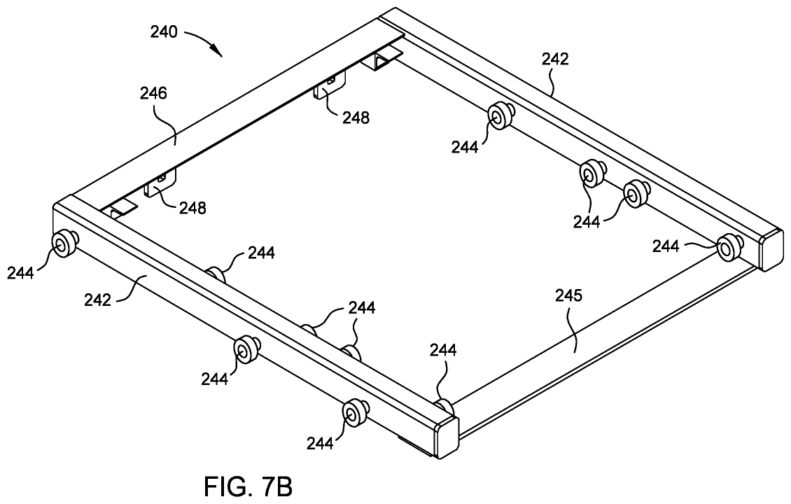

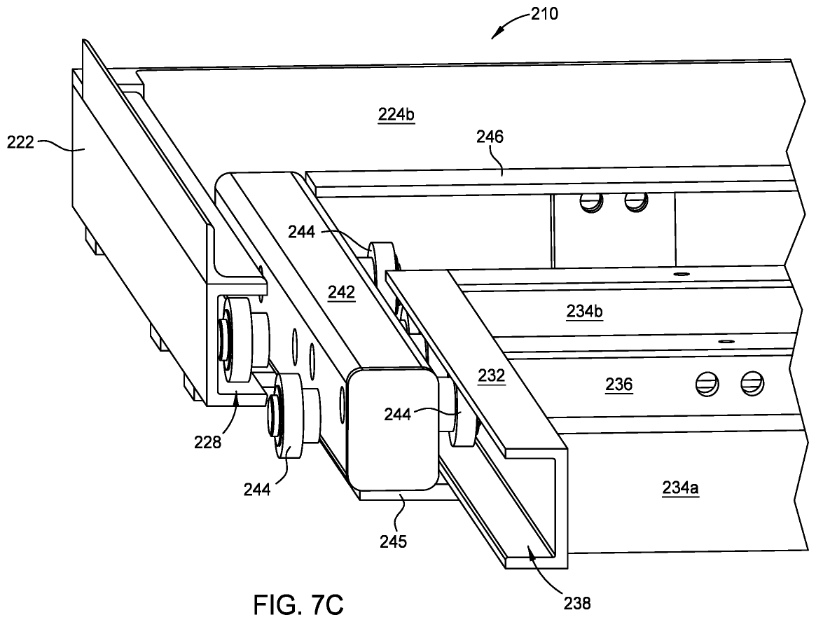

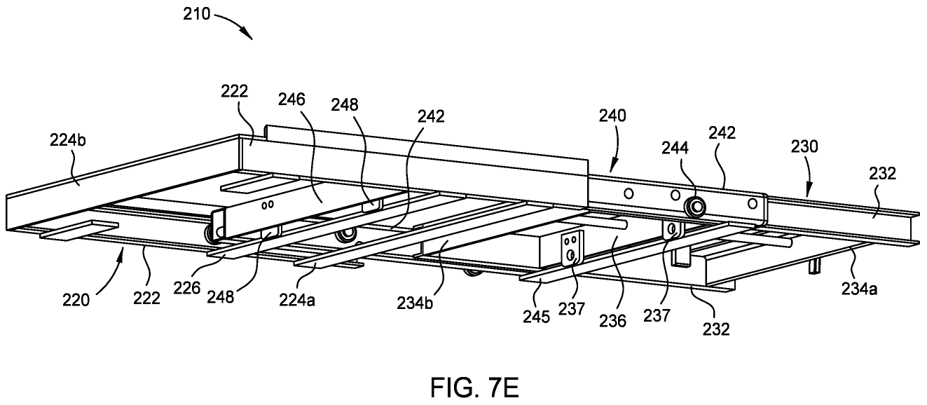

The first step module 260 is attached to an upper, or second, slide assembly 210 located within the interior volume of the housing 110. The upper slide assembly 210 is shown in greater detail in FIGS. 7A to 7E. FIG. 7A shows the upper slide assembly 210 in a retracted configuration which corresponds to the position of the upper slide assembly 210 when the stair assembly 100 is in the stowed configuration of FIG. 1 and in the position shown in FIG. 2. Thus, the first step module 260 is considered to be in the retracted position when in the position shown in FIGS. 1 and 2. FIGS. 7D and 7E show the upper slide assembly 210 in an extended configuration.

As shown in FIG. 7A, the upper slide assembly 210 has a base frame 220 and a sliding frame 230. The upper slide assembly 210 has a front 212 and a rear 214. The base frame 220 is a rectangular structure including side struts 222 with crossbeams 224a, 224b connecting the side struts 222 at or near the front 212 and the rear 214, respectively. A bracing beam 226 connects between the side struts 222 part-way along a length of the base frame 220. It is contemplated that the base frame 220 may include any suitable number of bracing beams 226. The number of bracing beams 226 may be selected in order to provide an appropriate structural rigidity of the base frame 220.

The sliding frame 230 is mounted on the base frame 220. The sliding frame 230 is a rectangular structure including side struts 232 with crossbeams 234a, 234b connecting the side struts 232 at or near the front 212 and the rear 214, respectively. A bracing beam 236 connects between the side struts 232 part way along a length of the sliding frame 230. A stop plate 237 is attached to the bracing beam 236, and projects downward. It is contemplated that the sliding frame 230 may include any suitable number of bracing beams 236. The number of bracing beams 236 may be selected in order to provide an appropriate structural rigidity of the sliding frame 230. Each sliding frame 230 side strut 232 is formed as a beam having a U-shaped channel 238 along the length of the beam, with the opening of the U-shape facing outward from the sliding frame 230. In some embodiments, the channel along the length of the beam of each sliding frame 230 side strut 232 may take the form of a different shape. For example, the channel may be V-shaped, or may be open on one side, defining an L-shape.

As shown in FIG. 7A, each base frame 220 side strut 222 is formed as a beam having a U-shaped channel 228 along the length of the beam, with the opening of the U-shape facing toward the sliding frame 230. In some embodiments, the channel along the length of the beam of each base frame 220 side strut 222 may take the form of a different shape. For example, the channel may be V-shaped, or may be open on one side, defining an L-shape.

The sliding frame 230 is disposed with respect to the base frame 220 such that the opening of each sliding frame 230 side strut 232 faces the opening of the corresponding base frame 220 side strut 222. A bearing assembly 240 connects each sliding frame 230 side strut 232 with a corresponding base frame 220 side strut 222. The bearing assembly 240 is also illustrated schematically in FIG. 76. The bearing assembly 240 includes an intermediate beam 242 at each side, a connecting crossbeam 245 at the front, and a bump stop 246 extends from one intermediate beam 242 to the other intermediate beam 242 at the rear. The bump stop 246 is configured to inhibit movement of the sliding frame 230 beyond the rear of the bearing assembly 240. One or more stop plates 248 (two are illustrated) are attached to the bump stop 246, and project downward.

The arrangement of the base frame 220, bearing assembly 240, and sliding frame 230 is also illustrated schematically in FIG. 7C. Each intermediate beam 242 is located between each sliding frame 230 side strut 232 and the corresponding base frame 220 side strut 222, such that each intermediate beam 242 is substantially parallel with the corresponding sliding frame 230 side strut 232 and the corresponding base frame 220 side strut 222. Rollers 244, such as wheels, are affixed to each intermediate beam 242 such that some rollers 244 project into the U-shaped channel 164 of each base frame 220 side strut 222, and other rollers 244 project into the U-shaped channel 158 of each corresponding sliding frame 230 side strut 232. As best shown in FIG. 7B, it is contemplated that the vertical positioning of some of the rollers 244 may be staggered.

The bearing assembly 240 is arranged such that the sliding frame 230 can move with respect to the base frame 220 along a direction parallel to the orientation of the U-shaped channels 228 of the base frame 220 side struts 222 and the U-shaped channels 238 of the corresponding sliding frame 230 side struts 232. Thus, as illustrated in FIGS. 7A to 7E, when the base frame 220 is mounted such that the U-shaped channels 228 of the base frame 220 side struts 222 and the U-shaped channels 238 of the corresponding sliding frame 230 side struts 232 are horizontal, the sliding frame 230 can move horizontally with respect to the base frame 220. The base frame 220 side struts 222 and the bearing assembly 240 are arranged such that the intermediate beam 242 of each bearing assembly 240 is separated vertically from the base frame 220 crossbeams 224a, 224b and the base frame 220 bracing beams 226. The bearing assembly 240 and the sliding frame 230 side struts 232 are arranged such that the sliding frame 230 side struts 232, the sliding frame 230 crossbeams 234a, 234b, and the sliding frame 230 bracing beam 236 are separated vertically from the base frame 220 crossbeams 224a, 224b and the base frame 220 bracing beams 226.

When the sliding frame 230 is in the position as shown in FIG. 7A, the sliding frame 230 is in a retracted position and the upper slide assembly 210 is in the retracted configuration. When the sliding frame 230 is in the position as shown in FIGS. 7D and 7E, the sliding frame 230 is in an extended position and the upper slide assembly 210 is in the extended configuration. The sliding frame 230 has a fastener 250 that facilitates the securement of the sliding frame 230 in the retracted position. As illustrated, the fastener 250 includes a rod 252 with a tang 254 attached thereto. The tang 254 interacts with the base frame 220 bracing beam 226, thereby preventing movement of the sliding frame 230 from the retracted position as shown in FIG. 7A to the extended position as shown in FIGS. 7D and 7E. The fastener 250 is unlocked by rotating the rod 252, such as by manipulating the attached handle 256, until the tang 254 is clear of the base frame 220 bracing beam 226. It is contemplated that one or more other locking mechanisms may be used in place of, or in addition to, the fastener 250.

FIG. 7E shows an underside view of the upper slide assembly 210 in an extended configuration after unlocking the fastener 250 and moving the sliding frame 230 horizontally with respect to the base frame 220. FIG. 7E shows two stop plates 237 interacting with the crossbeam 245 of the bearing assembly 240, thereby preventing further extension of the sliding frame 230 with respect to the bearing assembly 240. Additionally, the one or more stop plates 248 of the bearing assembly 240 interact with the bracing beam 226 of the base frame 220, thereby preventing further extension of the bearing assembly 240 with respect to the base frame 220. As illustrated, the sliding frame 230 has moved with respect to the base frame 220 a greater distance than the bearing assembly 240 has moved with respect to the base frame 220.

In some embodiments, the sliding frame 230 may have an additional fastener that facilitates the securement of the sliding frame 230 in the extended position. It is contemplated that the additional fastener may include an additional tang that interacts with the crossbeam 224a of the base frame 220 located at the front of the base frame 220, such that the sliding frame 230 is inhibited from moving horizontally toward the retracted position. The additional tang may be attached to the rod 252 of the fastener 250, and may be operated in a similar fashion to the fastener 250.

In some embodiments, it is contemplated that the sliding frame 230 may be powered to move between the retracted and extended positions. For example, the sliding frame 230 may be hydraulically or pneumatically actuated by a piston-and-cylinder arrangement. Alternatively, one or more electric motors and suitable gearing may be used to move the sliding frame 230. It is contemplated that movement of the sliding frame 230 between the retracted and extended positions may be controlled from within the vehicle in which the stair assembly 100 is installed, such as by pushing a button or selecting a command on a menu. It is contemplated that movement of the sliding frame 230 between the retracted and extended positions may be controlled remotely from a key fob or by using a program installed on a mobile communications device, such as a smartphone, smartwatch, tablet, and the like.

In order to provide structural rigidity of the base frame 220, the sliding frame 230, and the bearing assembly 240, it is contemplated that the base frame 220, the sliding frame 230, and the bearing assembly 240 may be made from a strong and rigid material, such as a metal, such as steel. Other materials, such as composite materials, such as materials incorporating carbon fibers, are also contemplated.

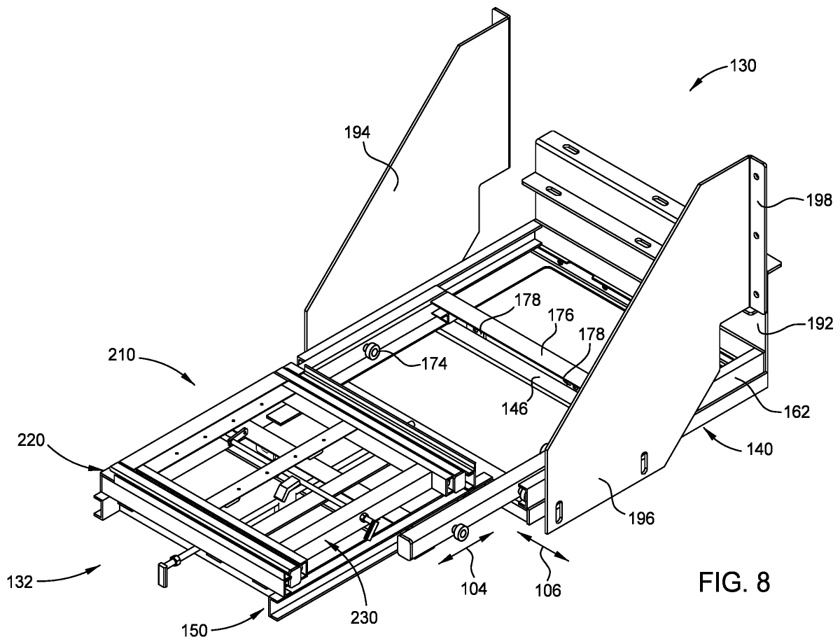

As shown in FIG. 8, the upper slide assembly 210 is mounted on top of the lower slide assembly 130. The upper slide assembly 210 base frame 220 is attached to the lower slide assembly 130 sliding frame 150. It is contemplated that the upper slide assembly 210 base frame 140 may be attached to the lower slide assembly 130 sliding frame 150 using any suitable fastening, such as clamps, bolts, screws, rivets, welding, and the like.

As illustrated in FIG. 8, the upper slide assembly 210 is arranged on the lower slide assembly 130 such that the lower slide assembly 130 sliding frame 150 moves between retracted and extended positions in a first direction 104, and the upper slide assembly 210 sliding frame 230 moves between retracted and extended positions in a second direction 106 that is different from the first direction 104. The second direction 106 is substantially perpendicular to the first direction 104. It is contemplated that the second direction 106 may be considered to be perpendicular to the first direction 104 within standard engineering tolerances. In some embodiments, it is contemplated that the second direction 106 may be substantially the same as the first direction 104. In some embodiments, it is contemplated that the second direction 106 may be the same as the first direction 104 within standard engineering tolerances. In some embodiments, it is contemplated that the second direction 106 may be at an acute angle to the first direction 104. As illustrated in FIG. 8, when the lower slide assembly 130 is viewed from the front 132, the upper slide assembly 210 sliding frame 230 moves from the retracted position to the extended position to the right. In some embodiments, it is contemplated that the upper slide assembly 210 sliding frame 230 may move from the retracted position to the extended position to the left.

FIG. 3 is a perspective view of the stair assembly 100 after a second deployment operation. In order to transition from the stowed configuration of FIG. 2 to the position shown in FIG. 3, the fastener 250 that retains the upper slide assembly 210 sliding frame 230 in the retracted position is unlocked, and then the upper slide assembly 210 sliding frame 230 is moved to the extended position. The first step module 260 is attached to the upper slide assembly 210 sliding frame 230, and therefore the first step module 260 has been moved from within the interior volume of the housing 110 to outside of the interior volume of the housing 110. It is contemplated that the unlocking of the fastener 250 may be performed manually, such as by turning the handle 256, or by prompting the fastener 250 to unlock via an electronic controller, such as by pressing a button, or such like. It is contemplated that the moving of the upper slide assembly 210 sliding frame 230 to the extended position may be performed manually, such as by pulling or pushing on a suitable component. As described above, in some embodiments the upper slide assembly 210 sliding frame 230 is powered to move between the retracted and extended positions. It is contemplated that the upper slide assembly 210 sliding frame 230 may be locked in the extended position shown in FIG. 3.

One or more legs 330 are deployed between the first step module 260 and the ground surface 354. The one or more legs 330 are configured to transfer a load to the ground surface 354. FIG. 4C shows the one or more legs 330 are attached to the upper slide assembly 210 sliding frame 230. It is contemplated that additionally or alternatively, the one or more legs 330 may be attached to the first step module 260. Each leg 330 has a foot 335 configured to rest on the ground surface 354. The feet 335 are configured to transfer a load to the ground surface 354. A height between the upper slide assembly 210 and each foot 335 is adjustable. In some embodiments, the one or more legs 330 may be configured to pivot with respect to the upper slide assembly 210 sliding frame 230 between stowed and deployed positions. In some embodiments, the one or more legs 330 may be telescopically adjustable with respect to the upper slide assembly 210 sliding frame 230, and may be telescopically adjustable between stowed and deployed positions. In some embodiments, the one or more legs 330 may be configured to pivot with respect to the upper slide assembly 210 sliding frame 230, and may be telescopically adjustable with respect to the upper slide assembly 210 sliding frame 230. Alternatively, it is contemplated that the one or more legs 330 may be stowed unattached to the upper slide assembly 210 sliding frame 230, and then may be attached to the upper slide assembly 210 sliding frame 230 to extend to the ground surface 354 after moving the first step module 260 to the position shown in FIG. 3. In some embodiments, the one or more legs 330 may be omitted such that the first step module 260 and upper slide assembly 210 sliding frame 230 remain cantilevered from the upper slide assembly 210 base frame 220.

The upper slide assembly 210 sliding frame 230 bears at least a portion of a weight of the first step module 260. Because the upper slide assembly 210 is mounted to the lower slide assembly 130 sliding frame 150, the lower slide assembly 130 sliding frame 150 bears at least a portion of a weight of the first step module 260 and a weight of the upper slide assembly 210.

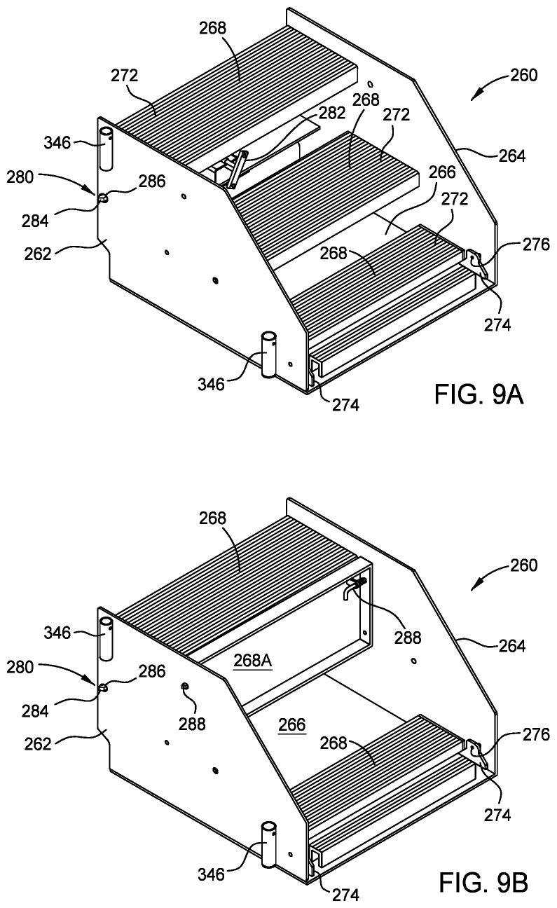

The first step module 260 is shown in more detail in FIGS. 9A and 9B. The first step module 260 has a first sidewall 262 attached to a floor 266 and a second sidewall 264 attached to the floor 266 on an opposite side to the first sidewall 262. In some embodiments, it is contemplated that the first sidewall 262, second sidewall 264, and floor 266 may be formed from a single sheet of suitable material that is bent into shape. In some embodiments, it is contemplated that the floor 266 may be omitted. In some embodiments, it is contemplated that the first sidewall 262 may be attached to a back plate and a second sidewall 264 attached to the back plate on an opposite side to the first sidewall 262. The first sidewall 262, second sidewall 264, and back plate may be formed from a single sheet of suitable material that is bent into shape.

As shown in FIG. 9A, a plurality of steps 268 extend from the first sidewall 262 to the second sidewall 264. It is contemplated that the first step module 260 may include any suitable number of steps 268. For example, the first step module 260 may include one, two, three, four, five, six, seven, eight, nine, ten, or more steps 268. Each step 268 is attached to the first sidewall 262 and to the second sidewall 264. Each step 268 is configured to facilitate a person standing thereon. It is contemplated that each step 268 may have an upper surface 272 that inhibits the tendency of a person to slip. For example, the upper surface 272 may be treated with a non-slip coating, may include ridges or undulations, may include a non-slip matting, such as a rubber mat, or combination(s) thereof.

It is contemplated that the first sidewall 262, second sidewall 264, floor 266 (if present), back plate (if present), and each step 268 may be made from strong and rigid material, such as a metal, such as steel, or from a relatively light weight yet strong and rigid material, such as aluminum. Other materials, such as composite materials, such as materials incorporating carbon fibers, are also contemplated.

The first sidewall 262 has mounting points, such as receptacles 346, with each receptacle 346 being configured to receive a post 344 of a handrail assembly 340. As shown in FIG. 9A, the receptacles 346 are positioned on a side of the first sidewall 262 that is opposite to the side onto which each step 268 is attached. It is contemplated that the receptacles 346 may be positioned on the same side of the first sidewall 262 onto which each step 268 is attached. It is contemplated that the second sidewall 264 may have receptacles 346 similar to those of the first sidewall 262. It is contemplated that the receptacles 346 may be positioned on the same side of the second sidewall 264 onto which each step 268 is attached. It is contemplated that the receptacles 346 may be positioned on a side of the second sidewall 264 that is opposite to side of the second sidewall 264 onto which each step 268 is attached.

The first step module 260 also includes brackets 274. Each bracket 274 is mounted adjacent to the lowermost step 268 close to where each sidewall 262, 264 meets the floor 266. Each bracket 274 has a hole 276 configured to receive a corresponding pin 312 (shown in FIG. 4A) or trunnion of the second step module 310.

As shown in FIG. 3, the first step module 260 is attached to the upper slide assembly 210 sliding frame 230. It is contemplated that the first step module 260 may be attached to the upper slide assembly 210 sliding frame 230 using any suitable fastening, such as clamps, bolts, screws, rivets, welding, and the like. For example, the floor 266 of the first step module 260 may be bolted to one or more bracing beam 236 of the upper slide assembly 210 sliding frame 230. Because of the attachment of the first step module 260 to the upper slide assembly 210 sliding frame 230, the upper surface 272 of at least one step 268 of the first step module 260 defines a plane that is substantially parallel to a plane in which the upper slide assembly 210 sliding frame 230 moves throughout the entire movement of the upper slide assembly 210 sliding frame 230 between retracted and extended positions. Thus, in embodiments in which the upper slide assembly 210 sliding frame 230 moves substantially horizontally, the upper surface 272 of at least one step 268 of the first step module 260 defines a plane that is substantially horizontal throughout the entire movement of the upper slide assembly 210 sliding frame 230 between retracted and extended positions.

Returning to FIG. 9A, the first step module 260 also includes a latch 280. A lever 282 is manipulated in order to cause a latch member 284 to extend and retract through a hole 286 in the first sidewall 262. It is contemplated that manipulation of the lever 282 may cause another latch member 284 to extend and retract through a hole 286 in the second sidewall 264. Each latch member 284, when in an extended position, interacts with a tab, such as tab 124 shown in FIG. 5, on the front fascia 116 and/or on the rear fascia 122 of the housing 110 to secure the first step module 260 in the extended position shown in FIG. 3. It is contemplated that one or more additional tabs may be located on the front fascia 116 and/or on the rear fascia 122 of the housing 110 to enable the latch 280 to secure first step module 260 in the retracted position shown in FIGS. 1 and 2.

FIG. 9B shows the first step module 260 with one of the steps 268A pivoted upwards. The pivoted step 268A is retained in the upwards position by a fastening 288, such as a latch. When the pivoting step 268A is in the position shown in FIG. 9B, space is provided to accommodate the second step module 310, as shown in FIG. 3.

In some embodiments, it is contemplated that the first step module 260 may be configured such that the floor 266 forms the lowermost step 268. In such embodiments, it is contemplated that where the floor 266 forms the lowermost step 268, the floor 266 may have an upper surface that inhibits the tendency of a person to slip. For example, the upper surface may be treated with a non-slip coating, may include ridges or undulations, may include a non-slip matting, such as a rubber mat, or combination(s) thereof.

FIGS. 4A to 4C are perspective views of the stair assembly 100 after a third deployment operation, and illustrating the stair assembly 100 in the deployed configuration. The second step module 310 is attached to the first step module 260 with pins 312 fastened through corresponding holes 276 of each bracket 274 of the first step module 260. Each corresponding pin 312 and bracket 274 forms a hinge, and thus the transition from the position shown in FIG. 3 to the position shown in FIGS. 4A and 4B involves pivoting the second step module 310 about the hinges.

As shown in FIG. 4A, the second step module 310 includes a first collapsible side frame 314, a second collapsible side frame 316, and a plurality of steps 318 extending from the first collapsible side frame 314 to the second collapsible side frame 316. It is contemplated that the second step module 310 may include any suitable number of steps 318. For example, the second step module 310 may include one, two, three, four, five, six, seven, eight, nine, ten, or more steps 318. Each step 318 is attached to the first collapsible side frame 314 and to the second collapsible side frame 316. Each step 318 is configured to facilitate a person standing thereon. It is contemplated that each step 318 may have an upper surface 322 that inhibits the tendency of a person to slip. For example, the upper surface 322 may be treated with a non-slip coating, may include ridges or undulations, may include a non-slip matting, such as a rubber mat, or combination(s) thereof.

The second step module 310 also includes feet 335 configured to rest on the ground surface 354. The feet 335 are configured to transfer a load to the ground surface 354. A height between the lowermost step 318 of the second step module 310 and each foot 335 is adjustable. The second step module 310 also includes a mounting point, such as receptacle 346, that is configured to receive a post 344 of a handrail assembly 340. The receptacle 346 is positioned on the first collapsible side frame 314. It is contemplated that the second step module 310 may include additional receptacles 346 configured to receive a post 344 of a handrail assembly 340. It is contemplated that the second step module 310 may include one or more receptacles 346 positioned on the second collapsible side frame 316 that are configured to receive a post 344 of a handrail assembly 340.

As shown in FIGS. 4A and 4B, a handrail assembly 340 that includes handrails 342 and posts 344 has been installed on the platform 112, the first step module 260 and the second step module 310. Each post 344 is received in a corresponding receptacle 346. FIG. 4B also shows posts 344 of the handrail assembly 340 received in receptacles 346 of the side fascia 126 of the housing 110. In some embodiments, the handrail assembly 340 may be stored dismantled in the interior volume of the housing 110 when the stair assembly 100 is in the stowed configuration, and then assembled as shown in FIGS. 4A and 4B. With the stair assembly 100 now in the deployed configuration, the stair assembly 100 is ready for use.

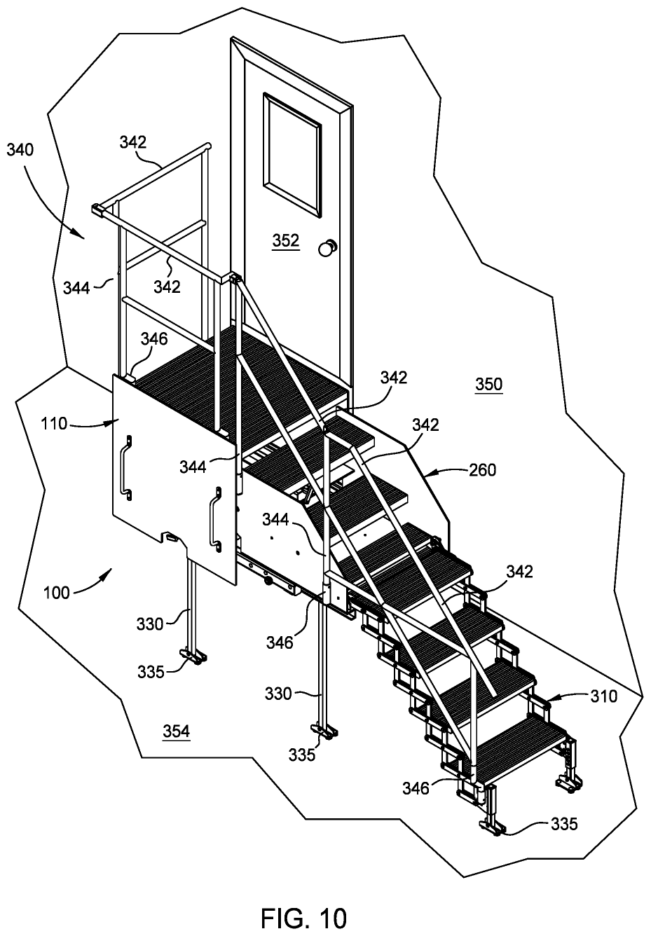

FIG. 10 shows the stair assembly 100 deployed and ready for use when installed on a vehicle 350. The platform 112 of the housing 110 is located adjacent to a door 352 of the vehicle 350. The first step module 260 and the second step module 310 are deployed to provide a sturdy stairway between the door 352 and the ground surface 354.

In some embodiments, it is contemplated that the second step module 310 may be omitted from the stair assembly 100. In such embodiments, the first step module 260 may be configured such that the lowermost step 268 is positioned at a convenient height from the ground surface 354. For example, the lowermost step 268 may be positioned lower than as shown in FIG. 10. Alternatively, the first step module 260 may be configured such that the floor 266 forms the lowermost step 268.

The stair assembly of the present disclosure may be installed in or on a vehicle. The stair assembly provides a stairway enabling people to enter and exit vehicles through doors that are elevated above a ground surface. The stair assembly is configured to be stowed as a compact unit in or on the vehicle, and may be deployed into a configuration that provides a robust and spacious stairway.

While the foregoing is directed to embodiments of the present disclosure, other and further embodiments of the disclosure may be devised without departing from the basic scope thereof, and the scope thereof is determined by the claims that follow.

What is claimed is:

1. A stair assembly comprising:
a first slide assembly comprising:
a first base frame, and
a first sliding frame mounted to the first base frame, and operable to slide horizontally with respect to the first base frame between retracted and extended positions;
a housing mounted to the first sliding frame and comprising a platform;
a second slide assembly mounted to the first sliding frame and comprising:
a second base frame, and
a second sliding frame mounted to the second base frame, and operable to slide horizontally with respect to the second base frame between retracted and extended positions; and
a first step module mounted to the second sliding frame and comprising a plurality of first steps;
wherein when the second sliding frame is in the retracted position, the first step module is located in the housing between the first sliding frame and the platform.

2. The stair assembly of claim 1, further comprising a second step module mounted to the first step module, the second step module comprising a plurality of second steps, wherein the second step module is movable with respect to the first step module between a first position in which the plurality of second steps is stowed and a second position in which the plurality of second steps is deployed.

3. The stair assembly of claim 2, wherein when the second sliding frame is in the retracted position and the second step module is in the first position, the second step module is located between the first sliding frame and the platform.

4. The stair assembly of claim 1, further comprising a handrail assembly configured to be mounted to the housing and the first step module.

5. The stair assembly of claim 1, further comprising one or more legs attachable to the first sliding frame and configured to transfer a load on the platform to a ground surface.

6. The stair assembly of claim 1, wherein:
the first sliding frame is configured to slide in a first direction;
the second sliding frame is configured to slide in a second direction; and
the first direction is different from the second direction.

7. The stair assembly of claim 1 further comprising a first fastener configured to retain the first sliding frame in the retracted position;

8. The stair assembly of claim 7, further comprising a second fastener configured to retain the second sliding frame in the retracted position;

9. The stair assembly of claim 2, wherein a first step of the plurality of first steps is movable with respect to the second sliding frame, thereby allowing the second step module to be moved into the first position.

10. The stair assembly of claim 1, wherein the first base frame is configured to be mounted to a frame of a vehicle.

11. A stair assembly comprising:
a first slide assembly comprising:
a first base frame, and
a first sliding frame mounted to the first base frame, and operable to slide horizontally in a first direction with respect to the first base frame between retracted and extended positions;
a housing mounted to the first sliding frame and comprising:
a first fascia coupled to a first end of the first sliding frame,
a second fascia coupled to a second opposite end of the first sliding frame, and
a platform coupled to the first and second fasciae, the platform, first and second fasciae, and first sliding frame defining an interior volume;
a second slide assembly mounted to the first sliding frame and comprising:
a second base frame, and
a second sliding frame mounted to the second base frame, and operable to slide horizontally in a second direction with respect to the second base frame between retracted and extended positions, the second direction perpendicular to the first direction; and
a first step module mounted to the second sliding frame and comprising:
first and second sidewalls, and
a plurality of first steps, each first step coupled to the first and second sidewalls;
wherein when the second sliding frame is in the retracted position, the first step module is located within the interior volume.

12. The stair assembly of claim 11, further comprising a second step module, the second step module comprising:
a frame mounted to the first step module; and
a plurality of second steps mounted to the frame;
wherein the second step module is movable with respect to the first step module between a first position in which the plurality of second steps is stowed and a second position in which the plurality of second steps is deployed.

13. The stair assembly of claim 12, wherein when the second sliding frame is in the retracted position and the second step module is in the first position, the second step module is located within the interior volume.

14. The stair assembly of claim 12, wherein a step of the plurality of first steps is movable with respect to the first and second sidewalls, thereby allowing the second step module to be moved into the first position.

15. The stair assembly of claim 11, wherein at least one of the housing, the first step module, and the second step module further comprises one or more mounting points configured to connect to a handrail assembly.

16. The stair assembly of claim 11, further comprising one or more legs attachable to the first sliding frame and configured to transfer a load exerted on the platform to a ground surface.

17. The stair assembly of claim 16, wherein the one or more legs are configured to pivot with respect to the first sliding frame between stowed and deployed positions.

18. The stair assembly of claim 16, wherein the one or more legs are telescopically adjustable with respect to the first sliding frame between stowed and deployed positions.

19. The stair assembly of claim 11, wherein the first base frame is configured to be mounted to a frame of a vehicle.

20. A method of deploying a stair assembly, the method comprising:
horizontally moving a platform mounted on top of a sliding frame with respect to a base frame, wherein the sliding frame bears at least a portion of a weight of the platform;
horizontally moving a first step module mounted on top of the sliding frame and below the platform with respect to the platform, wherein the first step module comprises a plurality of first steps; and
moving a second step module with respect to the first step module from a stowed position to a deployed position, wherein the second step module comprises a plurality of second steps coupled to the first step module.
